(19) United States
(12) Patent Application Publication
(10) Pub. No.: US 2010/0281073 A1
(43) Pub. Date: Nov. 4, 2010

(54) SEQUENCE PRESERVING METHOD FOR TRANSFERRING AND SHARING IMAGES

(76) Inventors: Robert P. Cloutier, Spencerport, NY (US); John R. Fredlund, Rochester, NY (US); Thomas J. Murray, Cohocton, NY (US); Frank Razavi, Fairport, NY (US)

Correspondence Address: Peter P. Hernandez, Patent Legal Staff;Eastman Kodak Company, 343 State Street, Rochester, NY, 14650-2201, US

(21) Appl. No.: 12/431,817

(22) Filed: Apr. 29, 2009

(51) Int. Cl. G06F 17/30

(52) U.S. Cl. 707/809; 707/E17.009

(57) ABSTRACT

A method for sharing one or more image files, the method includes the steps of providing a first set of image files on a first memory device; and transferring a second set of image from one or more second memory devices to the first memory device; wherein the second set of images have their file names converted to a file naming convention of the first set of images.

### FIELD OF THE INVENTION

This invention relates to sharing images between users of digital image capture devices and, more particularly, to preserving time order of the shared images.

### BACKGROUND

It is common for individuals to bring image capture devices to an event. In particular, at an event such as a birthday party, a number of people from different households will gather to celebrate the birthday. Often, several of the people at the event will capture images.

There is usually a desire to share images with others at the event. It is common practice to show the images captured by one camera to others who were not operating that particular camera. The operator of a first camera will often show images captured with the first camera to the operator of a second camera. In turn, the operator of the second camera will show the images captured with the second camera to the operator of the first camera. This method of sharing suffers from the limited size of the screens on the devices. Typically, the operator of the first or second camera will desire to have the images from the other camera. Also, after the event, any particular image is no longer accessible by anyone but the operator of the camera that captured any particular image.

There are many other means for sharing captured images. The users can download the images from the cameras to their computers. Once the images are resident on the computer, the operator can send the images to others attaching the images to e-mails. This process is often tedious, and presents a barrier to sharing images so that images often are not shared. Alternatively, the operators can upload the images from the computer to a photo-sharing site, such as the Kodak® EasyShare Gallery. The operator specifies the e-mail addresses of those with whom he desires to share images and an e-mail is generated and sent notifying the e-mail recipients. The recipient of the e-mail can access the website and see the images that have been uploaded. This process can also be tedious, and an additional barrier is presented by the bandwidth of the connection from the computer to the photo-sharing site.

Other photo-sharing websites allow public posting of images. In the case of Flickr, images are posted so that anyone can access them unless specified otherwise. This public access may not be preferred by family members.

If the image capture device has a wireless connection, images can be sent to others without use of a computer. For example, if the first camera is resident on a cell phone, the image can be sent from the camera to a server via a cellular link. Additionally, the server can forward the image to others designated by the first operator as an e-mail or cell phone message. This method is also limited by bandwidth, and can be expensive in terms of carrier charges for transmitting images.

U.S. Pat. No. 7,266,383 discloses a method for sharing images among a group of wireless devices. This method requires a local area network with which the devices must be able to communicate, and also a setup procedure for establishing a shared data pool.

U.S. Pat. No. 7,136,094 discloses a communications link between two image capture devices for permitting sharing images. This method requires one unit to be the master and another to be the slave. It also transfers images without regard to naming convention and subsequent display on the image capture devices.

U.S. Pat. No. 7,373,173 discloses a method of selective sharing of images with persons nearby at the time the images are captured. The capture device sends out an enquiry to determine the presence of other devices in the local area and determines who may be in the image captured by this means. This method requires that others with whom sharing is desired are carrying compatible devices, and that these devices are turned on. Furthermore, U.S. Pat. No. 7,373,173 requires a communications infrastructure on which images can be stored for sharing.

US Patent Application 20070120860 describes an archival imaging system that keeps a record in a recording device of what images have been recorded by that device. This device is an image archiving system with removable storage, and the record of recorded images resident on the device is referenced so as to prevent duplication of storage for images in the archival storage regardless if the removable archival storage medium is present or not. Additionally, the system is not used for sharing at an event.

Devices for copying image files are known. The Memorex TravlelLink is a battery powered device for copying files between two memory devices. This device will transfer selected files from one memory device to another. It provides a mode for moving individually selected files or the entire contents of one device to another. It is difficult to select images from an event for transfer without tedious review and individual selection of specific images.

Copying files presents many challenges. A direct connection of cameras may be desired, but this method presents many difficulties. A means of proper connections must be provided both mechanically and electrically. Currently this is an issue since many cameras do not provide this compatibility. This may be less of an issue as more devices support wireless communication, but additional issues will remain. The images desired for transfer must be selected. If there is a desire to view the transferred images in sequence with those images captured by a second user using a second camera, there will be an issue due to the mismatched naming conventions of different cameras. It may be difficult to find the images transferred and associate them with other images captured at the same event.

Consequently, a need exists for a method for easily sharing images at an event with a minimum of setup and involvement from the participants.

### SUMMARY

The present invention is directed to overcoming one or more of the problems set forth above. Briefly summarized, according to one aspect of the invention, the invention resides in a method for sharing one or more image files, the method comprising the steps of providing a first set of image files on a first memory device; and transferring a second set of images from one or more second memory devices to the first memory device; wherein the second set of images have their file names converted to a file naming convention of the first set of images.

These and other objects, features, and advantages of the present invention will become apparent to those skilled in the art upon a reading of the following detailed description when taken in conjunction with the drawings wherein there is shown and described an illustrative embodiment of the invention.

### BRIEF DESCRIPTION OF THE DRAWINGS

The present invention will be more readily understood from the detailed description of exemplary embodiments presented below considered in conjunction with the attached drawings, of which:

FIG. 1 illustrates an event including users and cameras;

FIG. 2 illustrates a device for sharing images, according to an embodiment of the present invention;

FIG. 3a illustrates a list of filenames for images resident on a device;

FIG. 3b illustrates a list of filenames for images resident on a device;

FIG. 3c illustrates a list of filenames for images resident on a device;

FIG. 4 illustrates a flowchart, according to an embodiment of the present invention;

FIG. 5 illustrates a flowchart, according to embodiments of the present invention; and

FIG. 6a illustrates a list of filenames for images resident on a device;

FIG. 6b illustrates a list of filenames with dates and times for images resident on a device;

FIG. 6c illustrates a list of filenames and a logfile for images resident on a device;

FIG. 7a illustrates a list of filenames for images resident on a device;

FIG. 7b illustrates a list of filenames with dates and times for images resident on a device;

FIG. 7c illustrates a list of filenames and a logfile for images resident on a device;

It is to be understood that the attached drawings are for purposes of illustrating the concepts of the invention and may not be to scale.

### DETAILED DESCRIPTION

The invention provides a system and method for sharing images at an event. A preferred embodiment takes the form of a device that accepts memory cards, but the invention is not so limited. The invention may take the form of software on a computer, or may be a feature of an image capture device. In all embodiments, the invention provides an easy means of sharing images among users.

An image file, or image, as used in this disclosure is understood to mean any still image, video sequence, or audio sequence that is captured by an image capture device.

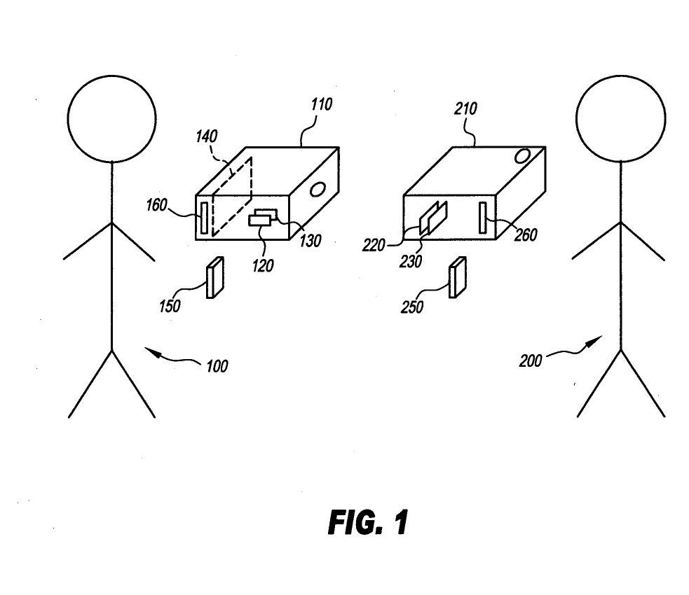

Referring to FIG. 1, at an event, user 100 captures image files 120 and 130 with camera 110. It is understood that digital camera 110 may be any digital camera, such as an Eastman Kodak Camera Model V803, or it may be a camera that is incorporated in a cell phone or personal digital assistant. At the same event, user 200 captures image files 220 and 230 with digital camera 210. Using the display 140 on camera 110, user 100 shows user 200 images that user 100 has captured. User 200 desires to have copies of image files of the event that user 100 has captured at the event.

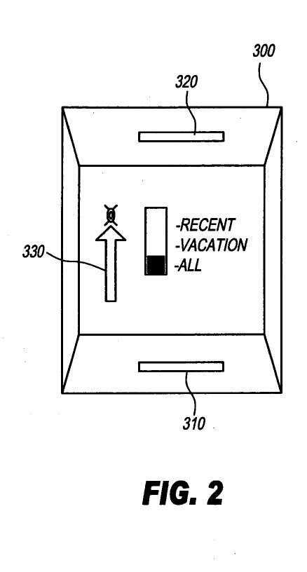

A preferred method of sharing copies of image files is provided as an example and it not intended to limit the scope of the present invention to this precise embodiment. User 100 removes the memory card 150 from the memory slot 160 of digital camera 110. Referring to FIGS. 1 and 2, memory card 150 is placed in the donor slot 310 of the transfer device 300. User 200 removes the memory card 250 from the memory slot 260 of the digital camera 210. The memory card 250 is placed in the receiver slot 320 of the transfer device 300. The slider switch 330 is placed in “All” position. When switch 330 is in this position, all images on memory card 150 will be transferred to memory card 250. However, since the file naming conventions are more than likely different, a file naming mismatch or a numbering mismatch may occur between the numbering sequence of the image files on memory card 150 and memory card 250. The transfer device 300 modifies the file names of each of the transferred files. To determine the initial condition for numbering copied files, transfer device first determines the highest numbered image file on receiver memory card 250, which in this example is 101_{—}0915.

Digital cameras typically display images on the basis of the image file naming convention. A particular camera will create a numbering scheme according to an arbitrary starting number, typically 100_{—}001 for Kodak cameras. This number will be incremented for each image or video sequence captured. Upon being placed in review mode, consumer digital cameras, such as the Kodak V803, will first display the highest numbered image and then work backwards from that number as the previous button is pressed to show successive images in reverse chronological order as the user continues to press the previous button. Conversely, if the user presses the next button and increases the number of the image when he is already viewing the highest numbered image, the camera will display the lowest number image and continue to increment upwardly through image numbers from that first image as long as the user continues to press the forward button.

This manner of displaying images is problematic when images are shared. If images from donor memory card 150 are merely copied directly to receiver memory card 250, there is no way to tell where in the sequence these copied images will be displayed since the numbering sequence, or at least the location in the numbering sequence, for camera 200 is likely to differ from that of camera 100. Therefore upon replacing receiver memory card 250 in camera 200, the newly copied images may or may not display in proper sequence with the images on receiver memory card 250. Additionally, there is the possibility that images from two different cameras may have the same file name. The desired outcome is that the shared images from camera 100 that have been transferred from donor memory card 150 to receiver memory card 250 will be displayed in sequence with those images captured by camera 200 and resident on memory card 250 for the same event. Additionally, it is desirable to maintain a record of which images have been copied from another source and which are captured by the user's camera, both to denote camera of creation, and to avoid double copying. Current prior art image capture devices do not provide this record, and do not provide for sequential viewing in which images from a particular event are clustered in an orderly fashion.

For example, if the images are merely copied from the donor memory card 150 to the receiver memory card 250 and the image filenames of the copied images are numerically higher than the image filenames captured by the camera 200 on the receiver card 250, the images will be displayed in sequence with the images captured by the digital camera 200. Common current practice dictates that when the digital camera 200 captures additional images after the image files from the donor card 150 have been copied, camera 200 reads the file numbers on receiver card 250 and names subsequent images in sequence with the highest number that has been copied. However, this scenario is fortuitous since the event clustering is maintained. Still further, grouping of images according to event may be handicapped due to the disparity (likely numerical gap) in filenames.

A different scenario occurs when the images are merely copied from the donor memory card 150 to the receiver memory card 250 and the image filenames of the copied images are numerically lower than the image filenames captured by the camera 200 on the receiver card 250. The copied images will not be displayed in sequence with the images captured by the digital camera 200. If all the images copied from the donor memory card 150 to the receiver memory card 250 have filenames that are numerically lower than the images on the receiver memory card 250, common current practice dictates that the copied images will be shown in sequence before all the captured images on the receiver memory card 250. Thus when the digital camera 200 captures additional images after the image files from donor card 150 have been copied, the copied images will be not be displayed in sequence with the images captured by the digital camera 200 at the event. The digital camera 200 reads the file numbers on the receiver card 250 and names subsequent images in sequence with the highest number, which is not one of the copied files. When the user views the files, he or she must search for them among all those on the receiver card 250.

Another undesirable scenario occurs when all or some of the images copied from the donor memory card 150 to the receiver memory card 250 have duplicate filenames. In this situation, the images must be renamed. This may be accomplished by renaming the copied images sequentially higher than the highest numbered filename on receiver memory card, or by adding a suffix to denote duplication, but this leads to difficulties when more than two users share images, as will be explained later.

There is also a method of copying images into a separate folder. This is problematic in that the receiving capture device does not always read additional folders or look for images within folders. For example, cameras typically store images in a primary folder, and if images are in another folder, the file will not be found.

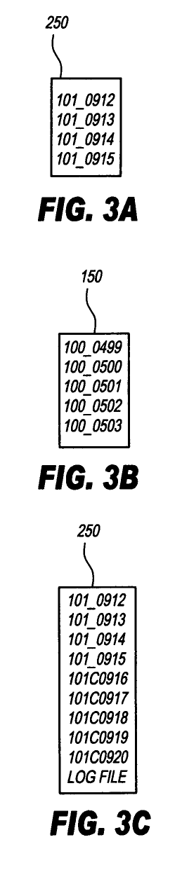

The present invention provides a method of achieving the desired outcomes. FIG. 3a is a representation of images residing on the memory card 250 that have been captured by the digital camera 200. FIG. 3b is a representation of images residing on the memory card 150 that have been captured by the digital camera 100. The user has selected the “All” position on the transfer device 300, so all of the images resident on the memory card 150 will be transferred to the memory card 250. Filenames are modified by the transfer device 300 so that the resulting image files will be resident on memory card 250 as shown in FIG. 3c. It is noted that the file name for the copied files replaces the underscore, “_”, with a “C.” The “C’ denotes that it is a copied file.

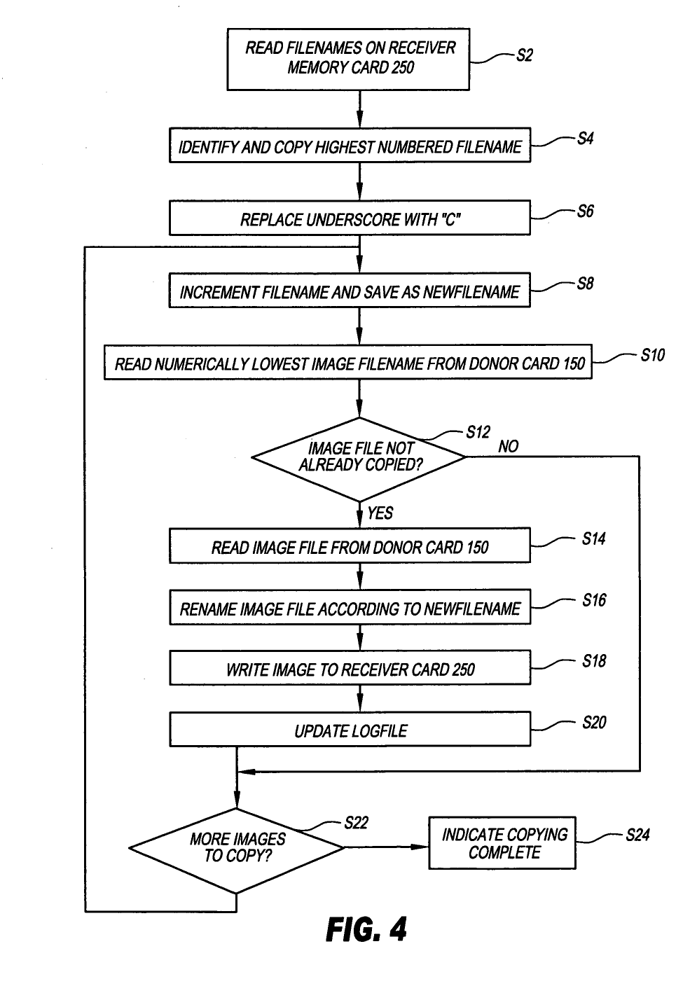

Since the user has indicated that he wishes all images to be transferred, the transfer device 300 will transfer each of the image files on the memory card 150 to the memory card 250. As shown in FIG. 4, the transfer device 300 (see FIG. 2) reads the filenames on receiver memory card 250 in step S2, and in step S4 identifies and copies the highest numbered image filename on memory card 250. The underscore in the filename is replaced with a “C” in step S6. This replacement conforms to the “Design rule for Camera File system DCF Version 2.0”. Since the file names are numerically based, the filename is incremented numerically and stored in step S8. In step S10, transfer device 300 reads the numerically lowest image filename from donor memory card 150. It is preferred to start with the lowest numbered filename although those skilled in the art may devise other methods conforming to the invention. In step S12, transfer device 300 determines if the image file in question has already been stored on receiver memory card 250. This is accomplished by comparing the filename and associated information to a logfile that is resident on receiver card 250. Alternatively, time and dates of capture, or some other unique metadata associated with the image file may be compared to make this determination in lieu of using the logfile. This technique will be described later. If there is no log file on receiver card 250, the logfile is created in this step. If the file read from the donor memory card 150 is already copied (“no” branch), transfer device 300 skips to step S22. If the file read from donor memory card 150 has not already been copied (“yes” branch”), the transfer device goes to step S14 and reads the image file from donor card 150. The image file is renamed in step S16 according to the stored filename saved previously in step S8. This renamed file is written to receiver card 250 in step S18, and updates the logfile accordingly in step S20. If all the images on donor card 150 are determined to have been copied in step S22, transfer device 300 moves to step S24 to indicate that copying is complete. If all the images have not been copied, transfer device 300 returns to step S8 and repeats the process until all the images are copied. At this point, in accordance with FIG. 3c, image files 100_{—}0499, 100_{—}0500, 100_{—}0501, 100_{—}0502, and 100_{—}0503 have been renamed as image files 101C0916, 101C0917, 101C0918, 101C0919, and 101C0920 and written to memory card 250. As described, the process for transferring all images from donor card 150 to receiver card 250 can create gaps in the numerical sequence of filenames when the donor card 250 has previously copied images residing on it. One skilled in the art can augment the example with additional steps to ensure that gaps are not created if this is important.

The log file is a record that is created on the receiver card 250 to indicate which images have been copied to receiver card 250. The log file records the original filename of each file copied and additionally the date and time of image capture as recorded in the original file header. It is not uncommon for different cameras to capture different image files and assign the same file name. However, the date and time of capture for two images captured by different cameras and assigned the same filename are very unlikely to be the same, so this data can be used to provide a means of determining if a file has been previously copied if filenames are the same. One skilled in the art may eliminate the logfile entirely. This may be accomplished according to the invention by using dates and times, or dates and times in conjunction with filenames, or using some other unique identifier for images for example but not by way of limitation, a hashing of the pixel values.

Note that the date and time need not be correct. It is common for users to improperly set the time and date on image capture devices. The present invention takes this into account by assuming that the highest numbered filename is the most recent image captured. The time and date recorded for images are regarded as current for that device. This is important in assuring that the proper images are copied and that they are displayed in an appropriate manner. This is significant in copying images in the recent or vacation modes, as shown by switch positions in FIG. 2.

Referring briefly to FIG. 3, when the user removes receiver memory card 250 from transfer device 300 and reinserts it in the camera 200, camera 200 will display image 101C0920. When the user continues to press the previous button, camera 200 will display image file 101C0919, 101C0918, 101C0917, 101C0916, 101_{—}0915, and so on. Thus the images captured by camera 200 will be displayed in sequence after the images copied from donor card 150 are displayed.

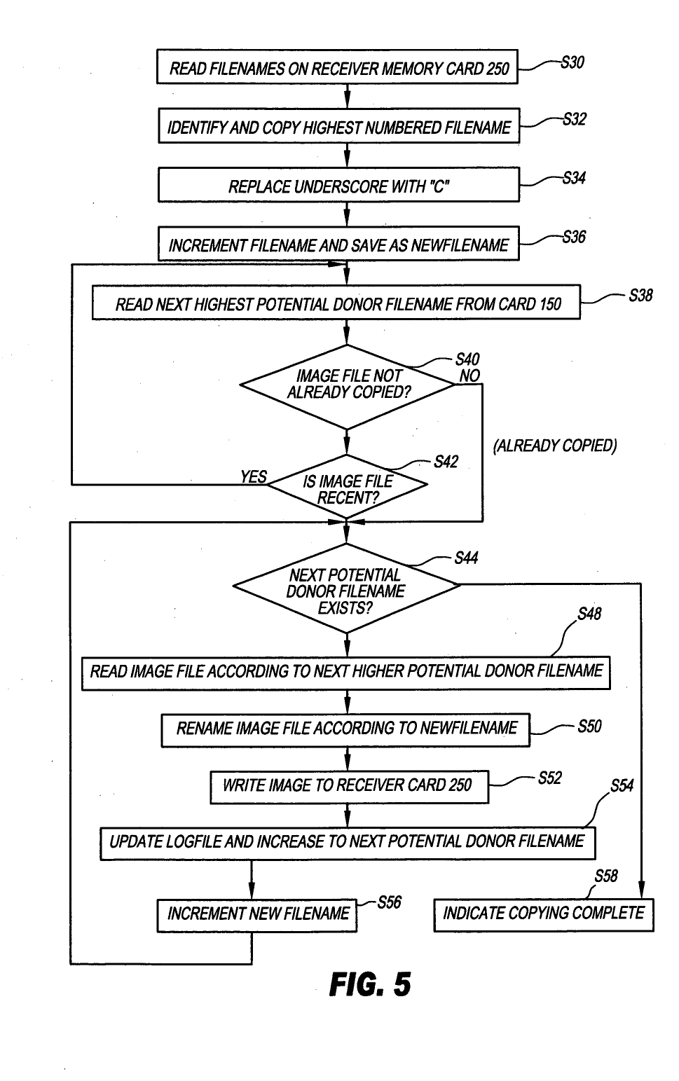

Another preferred method is shown in FIG. 5. In this case, slider switch 330 is placed in “Recent” position 350. When switch 330 is in this position, only recently captured images on memory card 150 will be transferred to memory card 250. For the purposes of this example, recent is defined as all image files on donor memory card 150 that are captured before a time period of 3 hours has elapsed between successive images. This period of time can be a fixed reference from the most recently captured image, or in the preferred embodiment, the period of time is adjusted with each subsequent image detected to have been captured within the previously determined time period. For example, when a 3 hour period of time is used, an image detected to have been captured 1 hour prior to the most recently captured image will extend the time period considered recent back another hour. Subsequent images captured within this updated time period will extend the recent period backward according to the time of capture of the subsequent images.

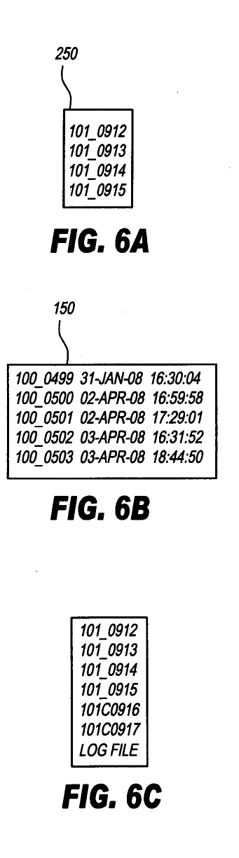

FIG. 6a lists the files initially on receiver card 250, and FIG. 6b shows the files on donor card 150. The time and date of capture is also shown for each file on donor card 150. Both cards are inserted in transfer device 300 as described earlier.

Returning to FIG. 5, since the user has indicated that recent images are to be transferred, transfer device 300 will transfer each of the image files that qualify as recent on memory card 150 to memory card 250. Transfer device 300 reads the filenames on receiver memory card 250 in step S30, and in step S32 identifies and copies the highest numbered image filename on memory card 250. This is done to determine the starting number that will be used for renaming files. The underscore in the copied filename is replaced with a “C” in step S34. This replacement conforms to the “Design rule for Camera File system DCF Version 2.0”. The filename is numerically incremented and stored as newfilename in step S36. In step S38 (which reads down the filenames), transfer device 300 reads the next highest potential donor filename from donor memory card 150, which is the numerically highest filename on the card if this is the first image filename read from donor card 150. Note that for reading subsequent image filenames, due to on-camera deletions and the like, this may not be a consecutively numbered filename. Note also that filenames containing the “C” replacement of the underscore will not be considered, since those are copied images. This provides the added benefit of not allowing unauthorized copying. It is preferred to start with the highest numbered filename and read successively lower filenames, though one skilled in the art may implement the invention by using other schemes for reading images.

Steps S38, S40, and S42 comprise a loop to determine the filenames of the images that will be copied from donor card 150 to receiver card 250. In step S40, the transfer device 300 determines if the image file in question has already been copied. This is accomplished by comparing the filename and associated information to a logfile that is resident on receiver card 250. If there is no log file on receiver card 250, the logfile is created in this step. Alternatively, as previously discussed, metadata associated with the image files or other unique identifiers may be used in place of the logfile to make this determination. If the filename is determined to have already been copied, the transfer device reads the date and time associated with the filename from donor card 150. This is done so that duplicate file names for different images are not treated as having been previously copied. If these data match the data saved in the logfile for the filename in question, the image has already been copied (“no” branch) and transfer device 300 skips to step S44. If there is no corresponding next higher potential donor filename S44, as is the case when the highest numbered filename has been copied or if there are no files that have not been copied (which includes the case when a copied filed has been read), transfer device 300 skips to step S58 and indicates that copying is complete, because if the highest numbered filename has been copied, the recent images have already been copied. If the next higher potential donor filename exists, transfer device 300 proceeds to step S48 and reads the image corresponding to the next higher potential donor filename.

Returning to step S40, if the image file in question is determined to not have been copied in step S40, transfer device 300 goes to step S42 and determines if the image in question is recent. This is done by comparing the date and time of the image file in question with that of the previously higher numbered image file. In the case of the highest numbered filename that exists on donor memory card 150, there is no next higher numbered image file, and the process continues on to step S44. If the image filename in question is determined to be recent, the process flows back to step S38 and repeats. In this manner, all of the filenames on donor memory card 150 for recent images are identified. If the image filename in question is determined to not be recent, then the process flows to step S44, which is the case when all the recent filenames on donor card 150 have been identified. Step 44 reads up the stack of recent images by determining if the next higher potential donor filename exists. If this next higher filename does not exist on donor card 150, it means that all the recent image files on donor card 150 have been copied to receiver memory card 250, and in this case, the flow proceeds to step S58 to indicate that copying is complete. When the next higher potential donor filename is determined to exist in step S44, this file is renamed and written to receiver memory card 250 as shown in steps S48-S56 and the cycle repeats until all of the recent image files have been copied from donor memory card 150 to receiver memory card 250.

By this process, when the next image determined not to have been copied is in question, the stored date and time is used for comparison. If the difference between the stored date and time is less than the limit of 3 hours, the image is considered recent and will be renamed and copied. If the time difference is greater than 3 hours, the image is not recent, and transfer device skips to step S58 and indicates that copying is complete. As shown in FIG. 6c, image files 100_{—}0502 and 100_{—}0503 have been renamed as image files 101C0916 and 101C0917, and written to memory card 250.

The 3 hour test for recent images is an arbitrary time period. The time period considered recent may be selectable by additional switches (not shown) or otherwise selected by connection means or files supplied by memory cards. The operation of the transfer device 300 when “Vacation” mode is selected is such a case. Instead of a 3 hour elapsed time being the limitation for copying images, a 48 hour elapsed time is used based on the assumption that the image capture devices used by the users will capture images at least every other day during a vacation. When this mode is selected, the flow is much the same as shown in FIG. 5 with a 48 hour limit used instead of a 3 hour limit. Also, if a first image is detected as having been copied, transfer device 300 must not abort the copy operation upon this detection because the image or images may have been copied with the recent setting employed, and now the more inclusive vacation setting has been chosen.

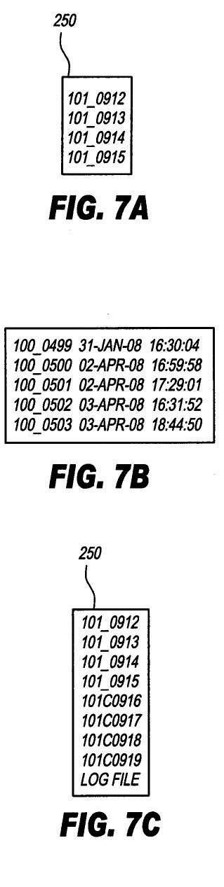

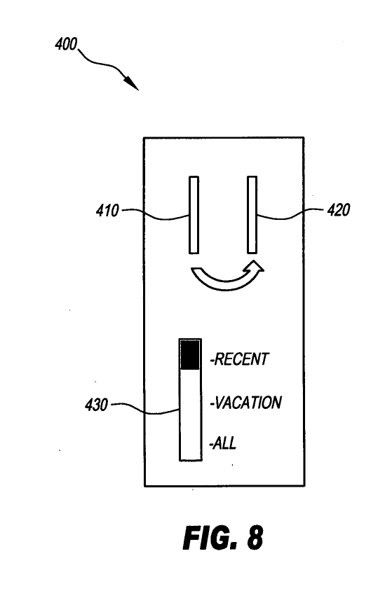

FIG. 7a shows the initial image files resident of receiver card 250. FIG. 7b shows the image files on donor card 150. Only image file 100_{—}0499 was captured more than 48 hours prior to the next highest image file number, so it is the only image not copied to receiver card 250 in FIG. 7c. For vacation mode, 100_{—}0500, 100_{—}0501, 100_{—}0503 are copied to receiver card 250 as 101C916, 101C917, 101C918 and 101C919 respectively.

The invention has been described with a one-way flow of image files. It is understood that this description has been provided for ease of understanding, and that two-way image flow may be enabled in the manner of the invention. One skilled in the art will realize that the invention can be implemented with a bi-directional flow of images rather than the unidirectional flow described.

Additionally, transfer device 300 may be designed with only one memory card slot if internal memory is provided. In this manner, the images from a donor card may be stored on transfer device 300 according to the desired setting of slider switch 330. After donor card 150 is removed, receiver card 250 is inserted and analysis a copying is performed as previously described.

The preferred embodiments of the invention have been described using the transfer device 300. However, the invention is not so limited. The transfer device 300 may be located in a camera or other image capture device. As shown in FIG. 8, a side view of camera 400 capable of using the invention, slot 410 and slot 420 are provided. Slot 410 is provided for a donor memory card 150 and slot 420 is provided for a receiver memory card 250. These slots can be provided in addition to a slot for normal camera image capture or one or the other may be the normal image capture slot for removable memory used for capture. Slider switch 430 is provided to allow selection as previously described. It is appreciated that this switch 430 may not be necessary since its function may be duplicated by other interface elements of camera 400. Operation of the device for sharing images is as previously described. Additionally, camera 400 may be designed with only one memory card slot if internal memory is provided. In this manner, the images from a donor card 150 may be stored on camera 400 according to the desired setting of slider switch 430. After the donor card 150 is removed, a receiver card 250 is inserted and analysis and copying is performed as previously described. Alternatively, analysis may be done on images on donor card 150 prior to copying any images so that only the desired images are copied from donor card 150.

The invention may also be practiced at a kiosk such as a Kodak Picture Kiosk. The kiosk may provide the single slot or dual slot method described above. The touch screen interface of the kiosk is used to make sharing selections.

If devices are so enabled, transference of physical media such as memory cards may be unnecessary. Zacks, in U.S. Pat. No. 7,027,836, Method and system for establishing a communication network, included herein by reference, describes a method and system for establishing a local communication network. This or other means can be used to establish a wireless connection between devices. Once connected, sharing may take place as previously described. The issues for transfer and viewing are largely the same, and the invention serves to simplify sharing in this case as well. A difference in the case of most wirelessly connected devices is that they provide an accurate time reference. This facilitates interleaving images copied from the donor device with images resident on the receiving device for display on the basis of chronology. However, either images captured by the receiving device must be renamed, or viewing must be done on the basis of chronology. Regardless, the implementation of the invention such that files are renamed to denote copied images is advantageous. Additionally, testing filenames and times and dates of images that may potentially be copied is advantageous in identifying images corresponding to events in accordance with time spans such as recent and vacation as described above.

It is to be understood that the exemplary embodiments are merely illustrative of the present invention and that many variations of the above-described embodiments can be devised by one skilled in the art without departing from the scope of the invention. It is therefore intended that all such variations be included within the scope of the following claims and their equivalents.

### PARTS LIST

100 user
110 camera
120 image file
130 image file
140 display
150 memory card
160 memory slot
200 user
210 digital camera
220 image files
230 image files
250 memory card
260 memory slot
300 transfer device
310 donor slot
320 receiver slot
330 slider switch
400 camera
410 slot
420 slot
430 slider switch

What is claimed is:

1. A method for sharing one or more image files, the method comprising the steps of:
(a) providing a first set of image files on a first memory device;
(b) transferring a second set of image from one or more second memory devices to the first memory device; wherein the second set of images have their file names converted to a file naming convention of the first set of images.

2. The method as in claim 1, wherein the file naming convention includes incrementing from a last captured file name of the first memory device.

3. The method as in claim 2, wherein the incrementing provides an order for display.

4. The method as in claim 1, wherein the file naming convention includes an indicator which indicates that the copied set of images originated from one of said second memory devices.

5. The method as in claim 4, wherein the indicator is used to indicate that no further copying of the copied images is allowed.

6. The method as in claim 4 further comprising the step of replacing an underscore of the file naming convention with a different character other than a number.

7. The method as in claim 1 further comprising the step of identifying those images to be transferred from the second set of images based on date or time of the second set of images.

8. The method as in claim 7 further comprising the step of using a date and time of creation of at least one image in the second set of images to determine which images are to be transferred.

9. The method as in claim 8 further comprising the step of using a date and time of the most recent image in the second set of images to determine which images are to be transferred.

10. The method as in claim 9 wherein a time-duration from the time and date of the most recent image is a predetermined fixed duration.

11. The method as in claim 10, wherein the predetermined duration can be adjusted by a user.

12. The method as in claim 8, wherein time durations are used from more than one image.

13. The method as in claim 8, wherein the recorded time and date of the most recent image in the second set of images is used only as a relative measure.

14. The method as in claim 1 further comprising the step of checking to ensure that any images from the second memory device are not already existing in the first memory device.
